(19) United States
(12) Patent Application Publication
(10) Pub. No.: US 2004/0240733 A1
(43) Pub. Date: Dec. 2, 2004

(54) Image transmission system, image transmission unit and method for describing texture or a texture-like region

(76) Inventors: Paola Hobson, Alton (GB); Timor Kadir, Oxford (GB)

Correspondence Address: MOTOROLA, INC., 1303 EAST ALGONQUIN ROAD, IL01/3RD, SCHAUMBURG, IL, 60196

(21) Appl. No.: 10/478,122

(22) PCT Filed: May 23, 2002
(86) PCT No.: PCT/EP02/05716

(30) Foreign Application Priority Data
May 23, 2001 (GB) 0112540.0

(51) Int. Cl. G06K 9/00; G06K 9/46

(52) U.S. Cl. 382/170; 382/190

(57) ABSTRACT

A method for characterising texture or a texture-like region in an image includes the steps of obtaining saliency values (104) of an image or set of images and applying a threshold to the saliency values (108), to remove the less salient features. A three dimensional shape, for example a cuboid of a predefines size, is generated (210) and saliency space sampled by moving the cuboid across spatial dimensions of the saliency space. An estimation of z probablility density function of scales within that sample space is generated and texture or a texture-like region in the saliency space is characterised using the estimation. This provides a method by which texture can be classified within an image to aid image interpretation. In particular, the texture is classified independent of scale, orientation and illumination. The method is particularly useful for texture classification problems where: the scale is unknown, the scale may vary, or a general scene description is required.

### FIELD OF THE INVENTION

This invention relates to characterising texture within an image. The invention is applicable to, but not limited to, characterising texture using salient scale information in image analysis tools.

### BACKGROUND OF THE INVENTION

Future generation mobile communication systems are expected to provide the capability for video and image transmission as well as the more conventional voice and data services. As such, video and image services will become more prevalent and improvements in video/image compression technology will likely be needed in order to match the consumer demand within available bandwidth.

Current transmission technologies, that are particularly suited to video applications, focus on interpreting image data at the transmission source. Subsequently, the interpretation data, rather than the image itself, is transmitted and used at the destination communication unit. The interpretation data may or may not be transmitted in compressed form.

Two alternative approaches to image interpretation are known—the ‘image-driven’, or bottom-up, approach, and the ‘model-driven’, or top-down, approach.

The image-driven approach relies on features in the image, such as edges or corners, to propagate “naturally” and form meaningful descriptions or models of image content. A typical example is ‘figure-ground’ image segmentation, where the task is to separate the object of interest in the foreground from the background.

In the model-driven approach, information regarding content expectation is used to extract meaning from images. A typical example is object recognition where an outline Computer-Aided Design (CAD) model is compared to edges found in the image—an approach commonly used in manufacturing line inspection applications.

The key difference between the image-driven and model-driven approaches is in the feature grouping stage. In the image-driven approach, the cues for feature grouping emanate from the image, whereas in the model-driven approach the cues come from the comparison models.

In one variation of an image-driven approach, a number of small salient patches or ‘icons’ are identified within an image. These icons represent descriptors of areas of interest. In this approach, saliency is defined in terms of local signal complexity or unpredictability, or, more specifically, the entropy of local attributes. Icons with a high signal complexity have a flatter intensity distribution, and, hence, a higher entropy. In more general terms, it is the high complexity of any suitable descriptor that may be used as a measure of local saliency.

Known salient icon selection techniques measure the saliency of icons at the same scale across the entire image. The particular scale selected for use across the whole image may be chosen in several ways. Typically, the smallest scale, at which a maximum occurs in the average global entropy, is chosen. However, the size of image features varies. Therefore a scale of analysis, that is optimal for a given feature of a given size, might not be optimal for a feature of a different size.

It is known that scale information is important in the characterisation, analysis, and description of image content. For example, prior to filtering an image, it is necessary to specify the kernel size, or in other words the scale, of a filter to use as well as the frequency response. It is also known that filters are commonly used in image processing for tasks such as edge-detection and anti-aliasing.

Alternatively, scale can be regarded as a measurement to be taken from an image (region), and hence can be used as a descriptor. Certain types of image content, such as those containing large texture-like regions, can be efficiently described solely by their scale information.

Typical examples include images of natural scenes and aerial images. Such images often exhibit self-similarity, which an adequate scale measure can capture. For example, patches may contain features which occur at different scales, such as one patch may be composed of many small features, whereas an adjacent patch contains many medium sized features.

The description extracted from the image may be used for subsequent matching or classification of that image (region). One example may be in segmenting parts of an aerial image into different regions according to their texture-like properties.

In order to extract an appropriate scale description, the method must capture the scale behaviour of the most ‘dominant’, or in other words the most salient scales in an image.

There are three known techniques for analysing different textures of images. All three techniques suffer from drawbacks. The three techniques and their drawbacks are described in greater detail below:

(i) Recently Weikert, [J. Sporring, J. Weikert, “Information measures in scale-spaces”, IEEE Trans. Information Theory, Vol. 45, 1051-1058, 1999] published work in which the global scale behaviour of different textures is analysed using an entropy measure. He suggested the use of maxima in entropy to identify ‘important’ scales. He went on to suggest that the behaviour of entropy across scale be used as a ‘fingerprint’ to uniquely specify a particular texture.

A primary disadvantage with Weikert's proposed method for image processing is that it is global, in that it calculates the average entropy across the entire image. Hence it cannot be used to identify local texture patches. Furthermore his particular entropy measure is not invariant to illumination changes.

(ii) Morphological analysis (for example as described in L. Vincent and E. R. Dougherty's paper “Morphological segmentation for textures and particles” in E. R. Dougherty, editor, Digital Image Processing Methods, pages 43-102,publ. Marcel Dekker, New York, 1994) has been widely used in image processing. It has an inherent scale parameter and can be used to analyse the scale properties of an image.

The method is termed Morphological Volumetric analysis and works as follows: first an assumption is made about the foreground and background image intensities; often these are set to be white and black respectively. The image is treated as a surface, with the foreground considered as maxima on this surface and background as minima—assuming a black and white or grey-scale image. The morphological operation of erosion is successively applied to this surface, to reduce the volume under the image surface. This erosion process works by applying a structuring element to the image surface.

Essentially, this structuring element is a group of pixels with a pre-defined shape, grey-level and size (scale). An example of a common structuring element is a square made up of N×N pixels each with a grey-level value of 128; N represents the scale. At each successive step in the algorithm, the size of the structuring element is increased.

The erosion operation operates as follows: at each pixel location the image is unmodified or set to the background pixel value depending on whether the pixel values are greater or less than that of the structuring element respectively. In this way the image gradually becomes the background intensity level and the volume of the surface is steadily reduced. By measuring the reduction in volume at each stage (after erosion with a given scale structuring element), the scale composition of the image may be determined.

The primary problem with using a Morphological analysis approach is that it has to assume foreground and background pixel intensities. Also the grey-level of the structuring element has to be defined.

(iii) Wavelet techniques (for example as described in the paper by P. Scheunders and S. Livens and G. Van de Wouwer and P. Vautrot and D. Van Dyck, entitled “Wavelet-based Texture Analysis” published in the International Journal on Computer Science and Information Management vol 1, no 2, pp 22-34, 1998) are popular in general signal processing as they can analyse the multi-scale behaviour of signals. Unlike Fourier analysis, Wavelet techniques have good scale and spatial localisation. Many Wavelet-based techniques have been proposed to describe texture-like image regions. However, they generally take advantage of the multi-scale nature of the Wavelet transform, by looking for dominant scales in the signal. Dominant scales are assumed to be those with ‘large’ Wavelet coefficient magnitudes.

One drawback with the wavelet technique is its simple approach to determining which scales are dominant. Large coefficient magnitudes generally correspond to high intensity pixel values. Hence, for certain textures this can lead to dominance of a certain part of the image over more subtle but equally significant features.

One application for improved image processing methods is in the field of image analysis or image classification, for example as might be required in closed circuit television (CCTV) systems or other image communication systems where multiple images from a number of sources need to be differentiated.

The recent development of wireless cameras has enabled wireless based CCTV systems to be deployed faster and more cheaply than wired CCTV cameras. This is particularly useful for temporary installations. However, a problem can arise with the tracking of replacement cameras, as the monitors in the control room no longer have a physical connection to any one camera. In a wireless environment, an operator who expects the output from Camera-A to be displayed on Monitor-1 no longer has a guarantee that any previous relationship between Camera-A and Monitor-1 holds true. Furthermore, the deployment of Camera-A may change from shift to shift, or even within a shift.

A further problem may arise when a camera or monitor is out of action. Video feeds are likely to be swapped around as the most important areas are covered with the available working equipment. There is therefore a further need for automated, flexible tracking of CCTV cameras, particularly in being able to classify an image as being transmitted from a particular location within a wireless CCTV system.

Thus there exists a need in the field of the present invention to provide an image transmission system, an image transmission unit and method for describing texture or a texture-like region in an image wherein the abovementioned disadvantages may be alleviated.

### STATEMENT OF INVENTION

In accordance with a first aspect of the present invention, there is provided a method for characterising texture or a texture-like region within an image, as claimed in claim 1.

In accordance with a second aspect of the present invention, there is provided an image transmission unit adapted to perform any of the method steps of the first aspect of the present invention, as claimed in claim 26.

In accordance with a third aspect of the present invention, there is provided an image transmission system adapted to facilitate any of the method steps of the first aspect of the present invention, as claimed in claim 27.

In accordance with a fourth aspect of the present invention there is provided a storage medium storing processor-implementable instructions for controlling a processor to carry out any of the aforementioned method steps of the first aspect of the present invention, as claimed in claim 28.

### BRIEF DESCRIPTION OF THE DRAWINGS

Exemplary embodiments of the present invention will now be described, with reference to the accompanying drawings, in which:

FIG. 1 shows a flowchart for generating a database of texture characteristics, in accordance with the preferred embodiment of the invention.

FIG. 2 shows a 3-D representation of a sampling operation of saliency space using a 3-D slice that is used in the generation of the database of texture characteristics of FIG. 1, in accordance with the preferred embodiment of the invention.

FIG. 3 shows two examples of texture characteristics as generated using the flowchart of FIG. 1 with the 3-D slice arrangement of FIG. 2, in accordance with the preferred embodiment of the invention.

FIG. 4 shows a flowchart for classifying an unknown texture, in accordance with an enhancement to the preferred embodiment of the invention.

FIG. 5 shows a flowchart for generating a database of texture characteristics using a 2-D histogram, in accordance with a further enhancement to the preferred embodiment of the invention.

FIG. 6 shows a flowchart for generating multiple 2-D histograms to classify sets of textures for regions within an image, and in particular for classifying an unknown image based on a set of extracted texture characteristics, in accordance with a yet further enhancement to the preferred embodiment of the invention.

### DESCRIPTION OF PREFERRED EMBODIMENTS

In summary, the inventive concepts of the present invention, described below, overcome the limitations of the prior art approaches, as discussed above, by analysing the behaviour of salient scales in the image. The method has advantages in that it is photometrically invariant and does not assume foreground and background intensities. The saliency measure is based on local signal complexity rather than the large coefficient magnitudes as often used by purely Wavelet-based techniques.

In addition, the scale descriptor method described herein is an improvement over prior art arrangements because it can generate descriptors of texture which are robust to changes in illumination, changes in rotation. Another benefit is that it is a local measure, meaning that it can capture descriptors appropriate to a small area in the image (as opposed to across the whole image). Combinations of these characteristics from a number of small areas can be used to characterise entire images within a set of images.

The inventors of the preferred embodiment of the present invention have recognised that many video/image applications would be better served by interpretation of image data at the source, in order to facilitate remote analysis or interaction by human operator, rather than simple transmission. Where video transmission is required, the interpretation provided at the source may also be used to autonomously select key sequences and features, or enhance the value of the raw image data.

As such, the inventors of the present invention have further recognised that the use of image modelling and scene descriptors may be exploited to provide techniques to address the aforementioned problems of CCTV systems and other image classification applications. Here the content of the image or video may be extracted into a predefined model or descriptor language. The invention below is essentially a process of image understanding and interpretation, by means of characterising texture or a texture-like region within an image.

The inventive concepts of the present invention find particular applicability in the-fields of fault detection (industrial inspection), automated pattern or object detection (image database searching), terrain classification (military and environmental aerial images), and object recognition (artificial intelligence).

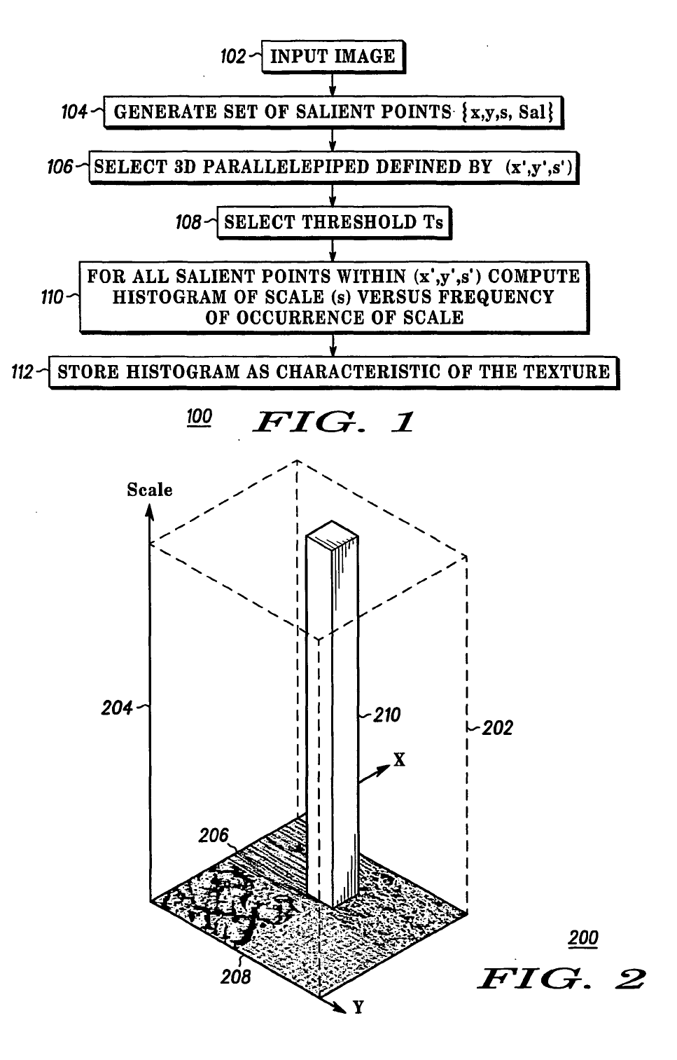

Referring first to FIG. 1, a flowchart 100 is shown for generating a database of texture characteristics for one or more images, in accordance with a first aspect of the preferred embodiment of the invention. An image is input, as shown in step 102, and a set of salient points generated as shown in step 104. A preferred arrangement for generating these salient points is described in co-pending UK patent application no. GB0024669.4 filed by the same applicant.

Saliency is a measure of the complexity of a local descriptor, as measured by the entropy of that local descriptor. Complexity defined in this way corresponds to local unpredictability. For example if the local descriptor were assumed to be the local intensity probability density function (PDF), then highly salient regions, i.e. complex regions, would be those with many intensity values all at similar proportions. In contrast, low saliency regions, i.e. regions of low complexity, would correspond to those containing a few intensity values. These regions would correspond to image regions with constant intensity.

A number of salient points are generated in the first aspect of the preferred embodiment, as shown in step 104. These are described by their location (x, y) and scale (s). The saliency (Sal) of each point is stored in a database.

In order to analyse the scale-space behaviour of signals and select appropriate sizes of local scale, i.e. the size of the region of interest window used to calculate the entropy, the method preferably searches for maxima in entropy for increasing scales at each pixel position. The method then assigns a weight to the entropy value with a scale-normalised measure of the statistical self-dissimilarity at that peak value.

As saliency is defined so as to select those features that are complex or unpredictable in the spatial dimensions, then the intention of the above step is to define the scale dimension self-similarity to correspond to predictability. Hence unpredictable behaviour over scale should be preferred; that is narrow peaks in entropy for increasing scales. The measure for self-similarity used in the preferred embodiment of the invention is the sum of absolute difference in the histogram of the local descriptor.

The calculation is as follows:

$$Sal ( s , \vec{x} ) = H ( s , \vec{x} ) \times W ( s , \vec{x} )$$

$$H ( s , \vec{x} ) = {\sum }_{i = 1}^{N} {p}_{i} ( s , \vec{x} ) {log}_{2} {p}_{i} ( s , \vec{x} )$$

$$W ( s , \vec{x} ) = S \times {\sum }_{i = 1}^{N} \vert {p}_{i} ( S , \vec{x} ) - {p}_{i} ( S + 1 , \vec{x} ) \vert$$

where N is the number of bins used in the histogram. Note ‘S’ may also be a vector as there may be more than one salient scale for a given spatial location. In essence, the method searches for peaks in entropy. The entropy calculation is made for each local maximum. This local maximum is where the function is greater than any neighbouring points, and hence the function is peaked. The saliency S at each of these points is calculated. One of the local maxima may be the same as the global maximum.

The next stage of the process is to create a 3-D volume such as a cylinder, rectangular parallelepiped, or other appropriate 3-D volume through scale. In the case of a rectangular parallelepiped, it may be defined by a 2-D projection onto (x, y) of dimensions (x′ by y′), and height defined in s of s′, as shown in step 106.

Experimentation by the inventors of the present invention showed that suitable values of x′ and y′ are fifty initially (but may be varied depending on the application and image content), and scale ‘s’ varying between ‘Smin’ and ‘Smax’, where ‘Smin’=5 and ‘Smax’=30 (for image dimensions 512×512).

In summary, the method generates a 3-D space (2 spatial dimensions plus scale) sparsely populated by scalar saliency values. As previously indicated, one concept of this invention is to characterise one or more texture regions within an image by scale salient features within such region(s). The selection of a particular region/saliency space enables the texture or textures of a particular region of the image to be classified by the scale parameters. The scale saliency space defined above is used to extract the appropriate descriptors.

By selecting a particular region of interest, the effect of introducing noise into the image analysis process is limited. As such, it is much easier to classify a particular texture within an image. Furthermore, it is then much easier to classify different regions within a single image as being of the same or similar texture, for example allowing all “brick-type” textures to be recognised as having the same texture characteristics.

Next, we describe the further novel processing steps we apply to this saliency space to obtain texture descriptions:

In the spatial dimensions (x, y), the window should be large enough to include a representative proportion of the texture. In the scale dimension, it should include all scales analysed in the saliency algorithm. Therefore a global threshold Ts is now selected, as shown in step 108. The global threshold is applied to the saliency values, to remove from consideration the less salient features.

Ts might be an absolute number, for example selected as the 100 points with the highest saliency values within the 3-D patch, or might be a percentage of all the points generated by the previous stages, for example taking the top 10% of the points in the 3-D patch. Typically a value of 60% of the value of the most salient feature as the threshold level can be used or alternatively 5% of the most salient features (in number). It is noteworthy that the choice of threshold is important. Too small a value and large texture features are lost. Too large a value and discrimination between similar textures with small features is difficult.

Referring now to FIG. 2, a 3-D representation of a sampling operation of saliency space is shown, in accordance with at least the first aspect of the preferred embodiment of the invention. The sampling operation shown uses a cuboid slice to generate a database of reference texture characteristics of FIG. 1, although other 3-D shapes such as cylinders or parallelepipeds may be used.

The 3-D cuboid 210 of FIG. 2 is preferably of a predefined size. The 3-D cuboid 210 is generated 200 and used to sample the saliency space 202. Such a cuboid 210 can then be used to generate a scale histogram to represent the texture of a particular region of an image.

To generate a database of representative or reference textures that can then be used for texture matching or classification, the cuboid 210 is preferably placed in the centre of each known or defined texture patch of an image. For better texture-recognition the cuboid can be moved across the spatial dimensions of the saliency space in the x-dimension 206 and the y-dimension 208, with the z-dimension 204 representing scale, as shown in FIG. 2.

Next, a histogram (approximating the PDF) of scales within this known or defined region of interest is generated, as shown in step 110 of FIG. 1. The histogram is a scale versus frequency of occurrence of this scale (discrete approximation to the PDF of scale i.e. an approximation to p(scale)) for the chosen region/patch. Although a histogram was used in experimentation, any approximation to the PDF of scale would be appropriate.

Advantageously, the inventors of the present invention have determined that it is possible to characterise different textures of an image by interpreting and comparing these histograms. The histogram is stored, as shown in step 112, characterising the texture of the known or defined region or patch of the image.

Furthermore, it is possible to classify the texture independent of the orientation and intensity information about the texture. In fact, and beneficially, this makes the method robust, i.e. independent of rotation and illumination change.

It is within the contemplation of the invention that a simple and direct method could be used to match the histogram of salient scales to ones obtained previously by using a histogram distance measure such as Mean-square error or Kullback contrast. Alternatively higher order statistics may be extracted from the histogram and matched to a database using, for example, a Bayesian technique.

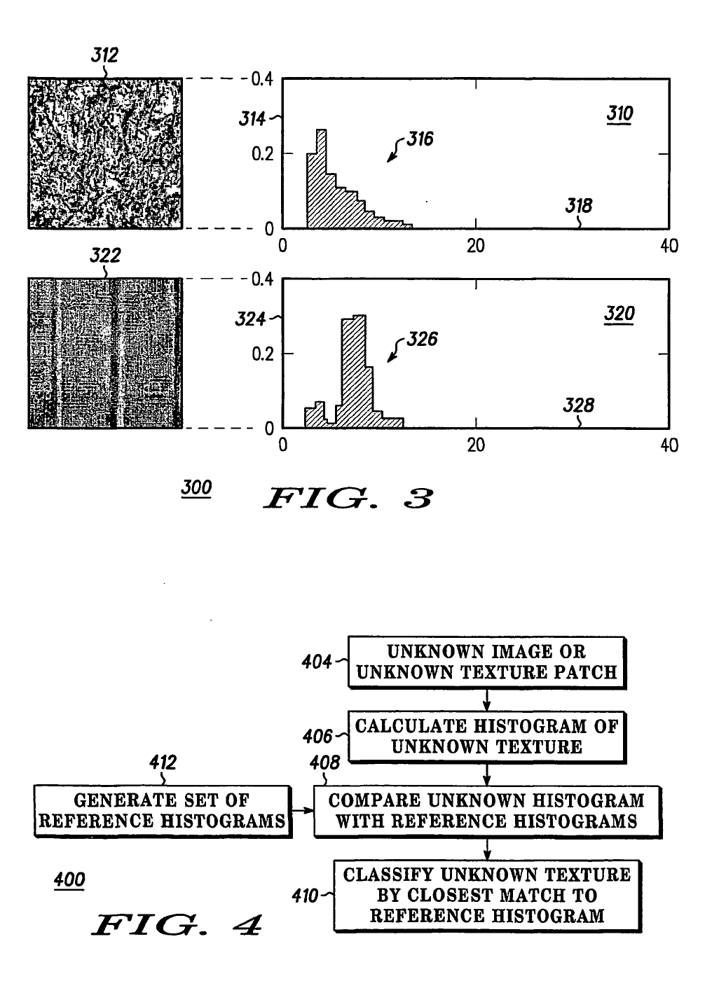

Referring now to FIG. 3, two histogram examples 300 of texture characteristics are shown, developed in accordance with the first aspect of the preferred embodiment of the invention. The texture characteristics are generated using the flowchart of FIG. 1 with the cuboid slice arrangement of FIG. 2.

The two texture histograms 310, 320 indicate their scale 318, 328 versus frequency of occurrence of this scale 314, 324. A set of reference histograms 316, 326 is generated, one histogram for each of the textures 312, 322 that are considered to be distinct textures that have some value and meaning within the particular image application.

For example, in environmental scanning, textures might relate to:

(i) different types of land use, for example, arable versus industrial,

(ii) different terrains, for example, mountainous versus flat,

(iii) different levels of built environment, for example urban versus rural, or

(iv) different composition, for example, lake, coast etc.

In summary, a method of classifying texture within an image has been described. The method includes selecting an image patch based on the saliency of the image content. A histogram of scale is generated which characterises the texture. It is then possible to classify other texture patches within the same image, or alternatively between images.

As an example, consider a set of references images, each containing just one reference texture (such as the well known Brodatz set). Application of the above method to a single patch of each image will produce a set of reference scale histograms, one for each image in the set of reference images. Application of the method to a different patch within one of these reference images of texture would produce an additional scale histogram. Comparison of this additional histogram against each member of the set of reference scale histograms already produced would reveal which reference image the patch came from, as a close match with one histogram in the database of reference scale histograms will be achieved.

Clearly, the above texture classification method can be used for known textures. However, in order to be robust to any new image, a second aspect of the preferred embodiment of the invention addresses the classification of unknown texture(s).

Referring now to FIG. 4, a flowchart 400 is shown for classifying an unknown texture, in accordance with an enhancement to the preferred embodiment of the invention. The flowchart shows that an unknown texture of an image or an image patch requires classifying, as in step 402.

To classify an unknown texture or unknown texture patch, the aforementioned steps associated with known textures are repeated (excluding storing the histogram as a reference), in order to generate a histogram of the unknown texture, as shown in step 406. The histogram of the unknown texture is then stored for future comparison against a set of reference texture histograms 412, as shown in step 408.

In order to classify an unknown texture of an image or an image patch, it is necessary to have built up a set of reference histograms 412, based on previous known textures. Such reference histograms have preferably been generated in accordance with the steps described with reference to FIG. 1.

It is within the contemplation of the invention that the set of reference texture histograms may be:

(i) pre-stored,

(ii) generated or updated dynamically as more images and textures are requiring classification or

(iii) programmed dynamically, for example over-the-air in a wireless communication system.

It is within the contemplation of the invention that the comparison/matching process in step 408 may be performed using any known method, such as a sum of squared differences, or any other method for comparing two histograms.

A classification of the unknown texture or unknown texture patch is then made, by determining the closest match of the texture to one of the reference texture histograms, as shown in step 410.

More generally, the set of reference histograms may be implemented in a respective communication unit in any suitable manner. For example, new apparatus may be added to a conventional communication unit, or alternatively existing parts of a conventional communication unit may be adapted, for example by reprogramming one or more processors therein. As such the required adaptation may be implemented in the form of processor-implementable instructions stored on a storage medium, such as a floppy disk, hard disk, PROM, RAM or any combination of these or other storage multimedia.

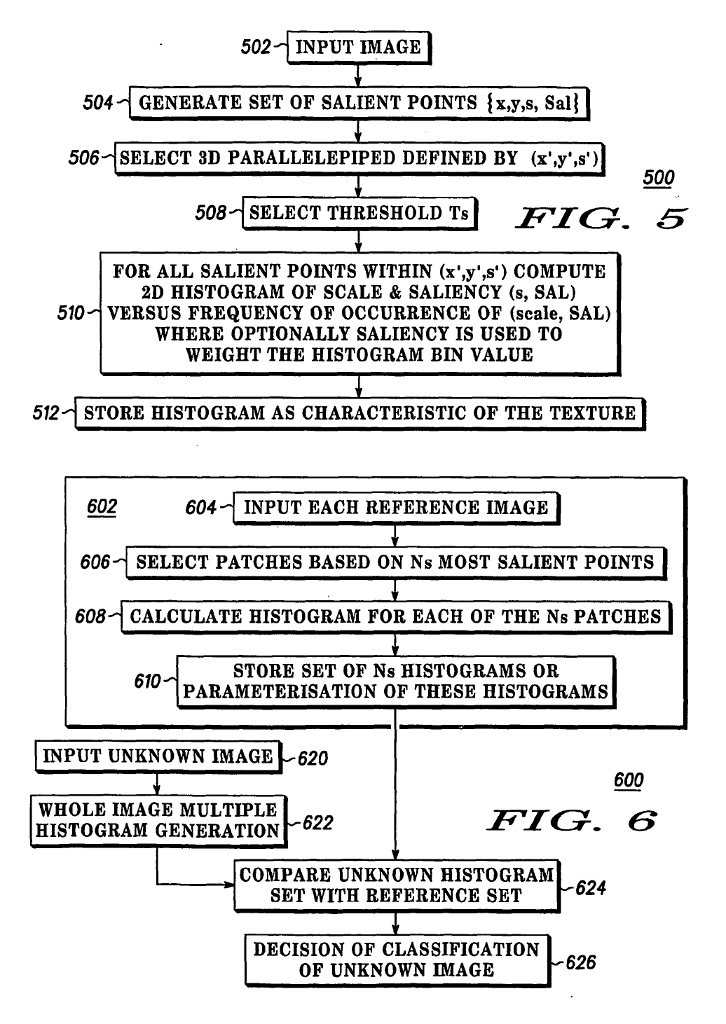

A saliency value may be taken into account in the classification process, in accordance with a further enhancement to the preferred embodiment of the present invention. By introducing a saliency value into the classification process, it is possible to improve discrimination between textures and to increase the number of texture classification classes. The saliency value is not scale invariant. Adding saliency to the information contained in each of the histograms improves the aforementioned scale-based methods, as described below with regard to FIG. 5.

FIG. 5 shows a flowchart 500 for generating a database of texture characteristics using a 2-D histogram in order to incorporate a saliency value, in accordance with the third aspect of the preferred embodiment of the invention. An image is input to the processing operation, as in step 502, and a set of salient point (dimensions x, y, scale, and a saliency value (Sal)) generated, as in step 504. Such salient points are preferably generated in accordance with the method described in co-pending UK patent application no. GB0024669.4, filed by the same applicant.

A 3-D parallelepiped (or other appropriate 3-D volume such as a cylinder) is selected, as shown in FIG. 2, defined by (dimensions x′, y′, and scale s′), as shown in step 506. The global threshold Ts is then selected, as shown in step 508.

At step 510 the histogram of scale is constructed. Notably, the histogram associated with FIG. 1 is replaced with a 2-D histogram computation, where a discrete approximation to a pdf of saliency and scale is generated. The resulting surface is the joint frequency of occurrence of each point in (scale, saliency).

A further step may optionally be applied where each point in the 2-D histogram is weighted by the saliency. In this case, rather than adding a ‘1’ to the histogram surface at a certain scale/saliency point each time it occurs, a non-linear function is used to generate a value to add to the histogram surface based on saliency. This reduces the impact of random noise. A simple example non-linear function (amongst many alternatives) might: add 3 to the histogram surface for each scale/saliency points if the saliency is above a threshold T1; add 2 to the histogram surface for each scale/saliency points if the saliency is between thresholds T1 and T2; add 1 to the histogram surface for all other scale/saliency points.

The 2-D histogram is then stored as a characteristic of the texture of the input image, as shown in step 512. In applying the 2-D histogram technique, using a saliency value, discrimination between textures has been improved and the number of distinguishable texture classes has been increased.

FIG. 6 shows a flowchart 600 for generating multiple 2-D histograms 602, preferably used to classify sets of textures for regions within an image. Furthermore, the flowchart is shown as extended to classify “sets of unknown textures” by comparing each of the unknown sets with “sets of reference textures”, in accordance with a yet further enhancement to the preferred embodiment of the invention.

In the extreme, a whole image may be classified by generating a 2-D histogram for each, or a number of the, texture(s) within the image. Alternatively, smaller patches of image may be used to generate the reference 2-D histograms for each member of the set of textures.

Each reference image of a whole image is input, as shown in step 604, and patches are selected based on a set of the Ns most salient points, as shown in step 606. A preferred arrangement for generating each texture histogram relating to such sets of salient points is described above and shown in FIG. 5.

At step 608 the histogram of scale/saliency is constructed for each texture or image patch, thereby generating a set or sets of reference histograms. Notably, the histogram associated with FIG. 1 may be replaced with a 2-D histogram computation, where a discrete approximation to a pdf of saliency and scale is generated. The resulting surface is the joint frequency of occurrence of each point in (scale, saliency).

The Bet of Ns histograms, or parameterisation of these histograms, relating to each reference image, may then be stored, as shown in step 610.

If the set of Ns 2-D histograms are stored, they can subsequently be used in the classification process for any unknown set of textures within an image or used to classify a whole image, as shown.

One or more inputs from an unknown image or unknown texture patches are input in step 620, then used to generate multiple histograms, as shown in step 622. These multiple histograms are then compared against the reference set(s) of 2-D histograms generated from steps 604-610, as shown in step 624. A classification of the unknown image or unknown image patches can then be made, as shown in step 626, by determining to which of the reference set of textures the unknown set is closest.

It is also within the contemplation of the invention that the reference texture histogram(s), or 2-D histogram(S), may be generated from an entire image, for example using reference textures such as the Brodatz set, or a texture patch or set of texture patches taken from an image. Furthermore, the reference texture histogram(s), or 2-D histogram(s), may be generated from averaging a number of histograms computed from one or more images, or one or more patches from the same or different images.

It is also within the contemplation of the invention that instead of using the 2-D histograms themselves as references and/or for classification of an unknown texture, or classification of an unknown image, a set of parameters that describe the histogram(s), or 2-D histogram(s), may be derived from the histogram(s). Such parameters may include (but are not restricted to) maximum, minimum, mean, variance, and higher order moments. Alternatively, mixture models may be used to parameterise the histogram, or 2-D histogram, for example Gaussian mixture models.

Use of parameterisation will decrease the complexity of the decision process (comparison between unknown and reference textures), and therefore increase the speed of decision making when classifying an unknown texture.

In particular for the case where 2-D histograms are used, it is within the contemplation of the invention that there may be more than one reference texture 2-D histogram used to represent a single texture. The stored reference for a given texture may be an average 2-D histogram plus a set of modes of variation, as is known in the technique of Principal Components Analysis (PCA).

Higher order dimensionality histograms or approximations to PDFs may also be used, such as a 3-D histogram of scale/saliency/spatial frequency, or a 3-D histogram of scale/saliency/luminance intensity.

In summary, this embodiment of the invention describes a novel method by which textures within an image can be classified, and thereby used to classify whole images. Although this invention is primarily viewed as a tool to aid image interpretation (and therefore the compact representation of an image in a communication environment), it also finds application within:

(i) the industrial inspection domain, for example seeking defects in textiles,

(ii) any surface where a defect would reduce the value of a product,

(iii) database searching, for example fashion and art image databases,

(iv) terrain classification, for example for military and commercial uses, and

(v) object recognition, for example in surveillance.

The proposed method is especially useful for texture classification problems where the scale is unknown (such as aerial imaging where much depends on the plane's height) or where the scale may vary (such as seeking defects in natural objects e.g. fish in food processing or farming, or where a general scene description is required (such as a consumer application on a 3^{rd} Generation cellular phone).

As multimedia communication systems become commodetised in the future, technologies such as those offered by this invention will enable users to efficiently communicate key features of an image, without having to pay for expensive bandwidth in order to send the entire image itself. This invention could be incorporated into any mobile image and video communication device, and as such has broad applicability.

In the above method of FIG. 1, the histograms are generated by counting the number of occurrences of each scale within the sample window, W, above a given threshold T (and dividing by the total number of salient features counted). This gives a measure of which scales are the most prominent in a given texture.

As an enhancement to this method, two dimensional histograms can be generated from the Scale/Saliency space, Sal(x,y,s); one dimension stores the scale of a particular feature and the other its saliency. The histograms, in accordance with a second aspect of the preferred embodiment of the present invention, represent both the proportion of which scales are present and their respective saliency values.

For example, two different textures may have a significant number of features at, say, scale ‘s’=10. However, in one, they may be predominantly of high saliency and in the other low saliency. In the aforementioned method this potentially useful information would be lost. However, by generating two-dimensional histograms this information is maintained and hence, the descriptors are better able to discriminate between textures.

As a further enhancement, the significance of each feature can be weighted by its saliency value. One limitation of the basic method is that a manual threshold has to be set, T. As with all hard threshold arrangements, there are some cases in which useful information is lost (i.e. it is below a particular threshold level). To alleviate this problem, a soft threshold can be used where a histogram count is incremented more for high saliency features (those with high Sal(x,y,s)), than those with low saliency. A threshold can still be used, but this can now be set very low so as to include most of the useful information.

Fast and reliable image classification methods are also needed for applications where an image may be searched for within a database of reference images. One example might be to identify the source or origin of an image sent from a CCTV camera when there could be a hundred or more CCTV cameras in any one monitoring system.

Clearly, once particular textures within a CCTV image have been used to generate a database of parameters (for example 2-D histograms) which act as a set of reference parameters representing an image or images of each class to be identified, then any unknown image (for example coming from an unspecified CCTV camera) can be assigned to one of the stored classes. This allows the origin or source of any image within the system to be identified.

As an example, consider a CCTV system with N cameras.

At the installation stage of this CCTV system (wired or wireless), a number of textures within one or more images can be acquired from each of the expected camera locations of these N cameras. For example, in the London Underground, there may be multiple cameras located in foot tunnels, on platforms, at the start and end of escalators, across passageways, station entrances and exits, access points to secure areas, etc. In future, further cameras may be situated in, and images taken from, the interior of the train carriages and the driver's cab.

It is then important to characterise textures or sets of textures associated with each camera location, such that subsequent images could be identified as coming from the same location, without needing to specify which camera took the image.

Therefore, for each expected camera location, the image(s) associated with that camera location are processed as described above. Either a set of scale histograms or a set of 2-D scale/saliency histograms, for the most salient patches of the image(s), are stored. Each stored set of histograms represents a unique identifier or class for each image (or set of images) from the expected camera locations. It is within the contemplation of the invention that higher dimensionalities are possible, such as adding spatial frequency as a 3rd dimension

Once these reference sets have been extracted from each set of images, from each expected camera location, they can be stored in such a way as to represent a unique “fingerprint” or class for the location.

Thus if an image from an unknown camera is presented to the system, a set of histograms (1-D, 2-D, 3-D or greater) are generated from it using the method(s) described above. The stored database is then searched to find the reference set that is closest to the set computed from the unknown image. The closest match determines the camera location at which the unknown image was acquired.

It will be understood that the communication system, communication unit and method for characterising texture or a texture-like region within images described above provide at least the following advantages:

(i) a method by which texture can be classified within an image to aid image interpretation. In particular, the textures are classified independently of scale, orientation and illumination;

(ii) have application within at least the following domains:

(a) industrial inspection, for example seeking defects in textiles, or any surface where a defect would reduce the value of a product),

(b) database searching, for example fashion and art image databases,

(c) terrain classification, for example in military and commercial uses, and

(d) object recognition, for example in surveillance applications;

(iii) useful for texture classification where:

(a) the scale is unknown, for example in aerial imaging where much depends on the plane's height, or

(b) the scale may vary, for example when seeking defects in natural objects, or

(c) a general scene description is required, for example such as a consumer application on a 3rd generation mobile cellular phone;

(iv) ability to characterise entire images such that subsequent images could be identified as coming from one of the reference sources;

(v) in applying the 2-D histogram embodiment: the use of scale and saliency in generating reference histograms allows greater discrimination between classes of texture, and enables a larger number of different textures to be classified; and

(vi) in employing the aforementioned embodiment to classify a whole image the inventive concepts can be applied to a larger number of image and object recognition problems, most importantly, that of whole image classification when there are a large number of similar images stored in an image database.

In summary, a method for characterising textures or a texture-like region in an image has been provided. The method includes the steps of obtaining saliency values of an image or set of images and applying a threshold to the saliency values, to remove the less salient features. A three dimensional shape is generated and the saliency space sampled by moving the three dimensional shape across spatial dimensions of the saliency space. An estimation of a probability density function of scales is generated within that sample space and textures or a texture-like region in the saliency space characterised using said estimation.

An image transmission unit adapted to perform the above method steps has also been provided.

In addition, an image transmission system adapted to facilitate any of the above method steps, has been provided.

Also, a storage medium storing processor-implementable instructions for controlling a processor to carry out any of the above method steps, has been provided.

Thus an image transmission system, an image transmission unit and a method for characterising textures or a texture-like region in an image has been provided wherein the abovementioned disadvantages associated with prior art arrangements have been substantially alleviated.

1. A method for characterising texture or a texture-like region in an image, the method comprising the following steps:
obtaining saliency values of an image or set of images;
the method characterised by the steps of:
applying a threshold to the saliency values, to remove the less salient features;
generating a three dimensional shape;
sampling the saliency space by moving the three dimensional shape across spatial dimensions of the saliency space;
generating an estimation of a probability density function of scales within that sample space; and
characterising texture or a texture-like region in the saliency space using said estimation.

2. The method for characterising texture or a texture-like region in an image according to claim 1, further characterised by the step of generating an estimation of a probability density function of scales within that sample space including generating a histogram of scales within a region of interest.

3. The method for characterising texture or a texture-like region in an image according to claim 2, wherein the step of generating a histogram includes generating at least a 2-D scale/saliency histogram.

4. The method for characterising texture or a texture-like region in an image according to claim 3, wherein the step of generating a 2-D histogram includes the steps of:
storing a scale value of a feature in a first dimension;
storing a saliency value of the feature in a second dimension; and
storing a frequency of occurrence of the jointly occurring scale/saliency values.

5. The method for characterising texture or a texture-like region in an image according to claim 3, the method further comprising the step of:
weighting the feature by its saliency value using a soft threshold; or
incrementing a histogram count using a non-linear function such that a larger increment is used for higher saliency features.

6. The method for characterising texture or a texture-like region in an image according to claim 1, the method further characterised by the histogram being generated from any of: an entire image, a patch taken from an image, a set of patches taken from an image, one or more images, one or more patches from the same or different images.

7. The method for characterising texture or a texture-like region in an image according to claim 2, the method further comprising the step of:
generating a set of reference histograms to be used to characterise an unknown image or unknown texture patch;
wherein the step of characterising texture or a texture-like region further includes the step of:
comparing a texture histogram or set of texture histograms generated from the unknown image or unknown texture patch to at least one reference texture histogram or at least one reference set of texture histograms; and
characterising the unknown image or unknown texture patch by matching the texture histogram or set of texture histograms to the closest reference texture histogram or set of texture histograms.

8. The method for characterising texture or a texture-like region in an image according to claim 1, the method further characterised by the steps of:
assigning a class to said texture or texture-like region for at least one type of image such that said class defines a unique identifier for said type of image; and
identifying a subsequent image as belonging to said class.

9. The method for characterising texture or a texture-like region in an image according to claim 2, the method further characterised by the step of:
deriving a set of parameters, for example maximum, minimum, mean, variance, and higher order moments, in order to characterise the histogram.

10. The method for characterising texture or a texture-like region in an image according to claim 2, the method further characterised by the step of:
generating mixture models to parameterise the histogram.

11. The method for characterising texture or a texture-like region in an image according to claim 9, wherein the use of parameterisation is applied to decrease complexity in the texture characterising step when classifying an unknown texture.

12. The method for characterising texture or a texture-like region in an image according to claim 1, the method further characterised by the step of representing a single texture using more than one reference texture.

13. The method for characterising texture or a texture-like region in an image according to claim 1, wherein a value of approximately 60% of a value of the most salient feature is used as the threshold level in the applying step.

14. The method for characterising texture or a texture-like region in an image according to claim 1, wherein, if more than one salient feature is obtained, a value of approximately 5% of the most salient features is used as the threshold level in the applying step.

15. The method for characterising texture or a texture-like region in an image according to claim 1, wherein the three dimensional shape is a cuboid of a predefined size in spatial dimensions sufficient to include a representative proportion of the texture.

16. The method for characterising texture or a texture-like region in an image according to claim 1, wherein the three dimensional shape is of a predefined size in a scale dimension sufficient to encompass all scales analysed in a saliency algorithm used in the step of obtaining saliency values.

17. The method for characterising texture or a texture-like region in an image according to claim 16, further comprising the steps of:
generating an estimation of a probability density function of scales within that sample space including generating a histogram of scales within a region of interest; and
matching the histogram of salient scales to histograms obtained previously by using a histogram distance measure, such as a Mean-square error or Kullback contrast.

18. The method for characterising texture or a texture-like region in an image according to claim 2, wherein the step of generating a histogram is performed by counting a number of occurrences of each scale within a sample window (W) above a given threshold (T) to provide a measure of the scales relevant to a given texture.

19. The method for characterising texture or a texture-like region in an image according to claim 2, the method further comprising the steps of:
extracting higher order statistics from the histogram; and
matching the higher order statistics to a database using a Bayesian technique.

20. The method for characterising texture or a texture-like region in an image according to claim 2, wherein the histogram is used, either directly or indirectly, to describe a local image patch of the image.

21. The method for characterising texture or a texture-like region in an image according to claim 2, the method further comprising the step of:
determining a set of texture histograms associated with a set of salient regions, some or all of which are stored as characteristics of each class of image.

22. The method for characterising texture or a texture-like region in an image according to claim 21, wherein the texture characterisation is performed in a CCTV system, the method further characterised by the step of:
identifying a camera location based on said stored characteristic of a class of said image.

23. The method for characterising texture or a texture-like region in an image according to claim 21, wherein texture information is generated for each salient region, with the information added to metadata already associated with the image.

24. The method for characterising texture or a texture-like region in an image according to claim 23, wherein the metadata is sufficient to allow discrimination between images such that it characterises an image.

25. The method for characterising texture or a texture-like region in an image according to claim 1, wherein the step of classifying a texture of an image includes the steps of:
selecting a plurality of regions of texture based on the image and obtained scale descriptors; and
classifying an image according to the closest set of texture types.

26. An image transmission unit adapted to perform the method of claim 1.

27. An image transmission system adapted to facilitate the method of claim 1.

28. A storage medium storing processor-implementable instructions for controlling a processor to carry out the method of claim 1.
